(19) United States
(12) Patent Application Publication
(10) Pub. No.: US 2026/0074504 A1
(43) Pub. Date: Mar. 12, 2026

(54) SMART CIRCUIT BREAKER MANAGEMENT SYSTEM

(71) Applicants: Indra Wiryadinata, BELMONT, CA (US); Ivan Zaitsev, MILPITAS, CA (US)

(72) Inventors: Indra Wiryadinata, BELMONT, CA (US); Ivan Zaitsev, MILPITAS, CA (US)

(21) Appl. No.: 18/826,201

(22) Filed: Sep. 6, 2024

(51) Int. Cl. H02H 3/00; H02H 1/00

(52) U.S. Cl. CPC H02H 3/00; H02H 1/0015

(57) ABSTRACT

A smart circuit breaker management system includes a cloud server, multiple application platforms, and multiple circuit breakers, the application platforms and the circuit breakers are connected to the cloud server through Internet, a cloud computing technology is used to replace a terminal host and analyze sensed data, facilitating users to create a smart home power management plan. A circuit breaker housing of each circuit breaker defines an accommodation space of the circuit breaker and has a first identification code provided for the application platform to register the cloud server and generate a corresponding platform data file before reading the first identification code to generate a device installation request in order to install the actually used circuit breaker, and the cloud server records, integrates, and sends the sensed data of each circuit breaker into the platform data file. Therefore, perfecting the safety of using power can be achieved.

### BACKGROUND OF THE DISCLOSURE

### Technical Field

The technical field relates to circuit breaker management systems in general, and more particularly relates to a smart circuit breaker management system.

### Description of the Related Art

Energy supply has become a heated issue around the world, with people worried about the depletion of fossil fuels and the potential danger of radiation from nuclear power, but also plagued by the inefficiencies of green energy sources, such as wind, water and solar power, which are often affected by the time of year and climate, and whose efficiency of energy conversion is still too low to meet actual consumer demand. Therefore, until energy alternatives are perfected, improving the efficiency of power protection and energy usage at the electric user end is a struggle for many in the technology field.

When it comes to power protection technology, a circuit breaker that can instantly disconnect abnormal currents to protect the power supply system is an indispensable safety control element in the power system. Circuit breaker is a kind of automated electrical switch components, its main function is to immediately and automatically cut off the power supply, in order to quickly isolate the failing area and avoid affecting the operation of the entire power system in the overcurrent and short-circuit conditions of the power system, thereby enhancing the reliability and stability of the power supply. At the same time, it can prevent equipment damage and fire to ensure the safety of human life and property. However, the above related-art circuit breaker usually only includes mechanical components and basic overcurrent and short-circuit protection functions and a simple structure but it just provides a single function that mainly relies on manual or mechanical drive to cut off and restore the connection between the circuit and the power supply, therefore, even though it has the feature of a shorter maintenance cycle, it is only for the application with a lower circuit protection demand. Obviously, the related-art circuit breaker does not meet the protection requirements of today's increasingly complex power systems.

Nowadays, various types of building facilities, commercial facilities, industrial facilities, data centers, etc. are digitized and developed intelligently, so that the quality, reliability and requirement of the power system are also increased in various different occasions, so the lack of communication and data analysis and other functions of the related-art circuit breaker has been clearly inadequate for the actual needs of the current power system. In order to overcome the above deficiencies, a kind of smart circuit breaker was proposed, in which microprocessors, various types of sensors and communicators, etc. are combined to provide not only overcurrent and short-circuit protections, but also covers the protections such as overload protection, ground fault protection, and remote control, etc., in order to build a remote monitoring system and realize more comprehensive service functions. However, this type of power monitoring system often needs to be paired with at least one panel gateway and a terminal host. After the panel gateway is used to set up the circuit breaker in each electrical device or circuit, and then to compile the data from each circuit breaker through the panel gateway and send the data to the terminal host for data computation and analysis. In this way, the limitation on the conditions of the circuit settings of the panel gateway, the data setting of the related circuit breaker, and the setting of the terminal host for controlling the backstage causes difficulties and discourage average users to start and build a power management system for the home, even if they are interested in improving electricity safety and want to build the smart home power management system.

In other words, even a large number of smart home appliances equipped with a mobile monitoring application (APP) have been implemented in the market to allow users to monitor home appliances through the APP, the monitoring is scattered and fragmented due to the fact that each APP is independent and self-administered, not only occupying a large amount of storage space of the mobile device held by users, but also consuming a large amount of monitoring time, which is not in line with the practical needs of home users. It is noteworthy that fires caused by malfunctioning appliances are one of the major causes of residential fires. In the comprehensive promotion of energy conservation and the call for improving the efficiency of electricity use, how to introduce the intelligent power management system into the home, so that the power management and safe use of electricity behavior can be implemented in the most subtle unit (each family) of the entire society demands immediate attentions and feasible solutions.

In view of this problem, how to provide a solution without requiring to set up the circuit and data of a panel gateway, or build and set up the terminal host, but just using the data communication through Internet to allow home users to monitor the power consuming situations of various electric appliances or circuits all at a time through the mobile device installed with APP. Therefore, it is a subject for the present disclosure to overcome the aforementioned drawbacks of the related art and provide immediate feedback of failure signals and warning reminders to achieve the best power protection and electricity safety effect.

### SUMMARY OF THE DISCLOSURE

It is a primary objective of the present disclosure to overcome the drawbacks of the related art by providing a circuit breaker management system that realizes intelligent power monitoring through cloud computing technology and artificial intelligence, so that general users can easily use mobile devices to systematically monitor the power consumption of all devices and circuits in the environment without the need to build a backstage management host, so as to effectively improve the safety of electricity usage, and the efficient planning of power deployment.

To achieve the aforementioned objective, the present disclosure discloses a smart circuit breaker management system provided for monitoring the power consumption of a plurality of device circuits through Internet, which includes: a cloud server; a plurality of application platforms installed in at least one mobile device separately, connected to the Internet, and connected to the cloud server through telecommunication, wherein each of the application platforms includes a management interface and a platform identity code, and the platform identity code is used to register the cloud server and create a corresponding platform data file; and a plurality of circuit breakers, which are smart circuit breakers and installed between an external power supply and one of the device circuits.

Each of the circuit breakers includes: a circuit breaker housing that defines an accommodation space of the circuit breaker, and the circuit breaker housing has a first identification code including a device number, and when the application platform receives one of the inputted first identification codes and analyzes the corresponding circuit breaker, a device installation request including the first identification code and the platform identity code is outputted via the Internet; a switch, installed in the circuit breaker housing and including an input terminal and an output terminal, the input terminal receiving the power of an external power supply and the output terminal transferring the power of the external power supply to the device circuit; an electric energy meter, installed in the circuit breaker housing and coupled to the input terminal for measuring an electricity transmission of the external power; a current detector installed in the circuit breaker housing and coupled to the output terminal for detecting a current flow, a current direction, or a ground fault current and then outputting a current data; an arc detector installed in the circuit breaker housing and coupled to the output terminal for detecting a current waveform and a voltage waveform and then outputting an arc data; a control processor installed in the circuit breaker housing and coupled to the switch, the electric energy meter, the current detector and the arc detector for receiving the electricity transmission, the current data and the arc data; and a wireless communicator installed in the circuit breaker housing and coupled to the control processor, and connected to the Internet, when the wireless communicator receives the device installation request, the control processor checks the first identification code and records the platform identity code when the checked first identification code is correct and feeds back a circuit breaker installation confirmation signal via the Internet, and makes the cloud server to record the circuit breaker into the corresponding platform data file which is provided for display through the management interface; and when the control processor receives the electricity transmission, the wireless communicator transmits the electricity transmission to the cloud server for collecting statistics, which is provided for displaying on the management interface; when the control processor receives the current data and computes the data to know about a current failure, the control processor turns off the switch and generates an OFF signal accordingly, and synchronously transmits the current data and the OFF signal to the cloud server, the cloud server checks the current data and verifies the OFF signal, to output a failure signal to the corresponding application platform when the failure is confirmed, and the failure signal and the current data are provided for display through the management interface; when the control processor receives the arc data and computes the data to know about an arc failure, the control processor turns off the switch and generate the OFF signal accordingly, and synchronously transmits the arc data and the OFF signal to the cloud server, the cloud server checks the arc data and verifies the OFF signal and outputs the failure signal to the corresponding application platform when the failure is confirmed, and the failure signal and the arc data are provided for display through the management interface.

In addition, the smart circuit breaker management system further includes at least one panel gateway including a microprocessor and a communication element connected to the Internet through telecommunication and the panel gateway is coupled to each of the circuit breakers, and the microprocessor is provided for compiling the data transmitted from each of the control processors, and then the communication element is provided for transferring the data to the cloud server, so as to achieve the effect of increasing the data transmission distance. Each of the panel gateways includes a second identification code with a panel gateway number, and when the application platform receives one of the inputted second identification codes, the application platform analyzes the corresponding panel gateway and outputs a panel gateway installation request including the second identification code and the platform identity code via the Internet, so that the microprocessor receives the panel gateway installation request through the communication element and checks the second identification code, and records the platform identity code when the checked second identification code is correct and feeds back a panel gateway installation confirmation signal via the Internet, so that the cloud server records the panel gateway into the corresponding platform data file.

When each of the circuit breakers is coupled to the panel gateway, the microprocessor reads and records the corresponding device number and feeds back the device numbers and the second identification codes for the cloud server to group the panel gateway and the circuit breakers with a connection relation upon the receipt of the panel gateway installation request and the feedback of the panel gateway installation confirmation signal, which are provided for display through the management interface. The first identification code and the second identification code are data matrices, quick response codes (QR Codes) or serial number codes, including the device number or the panel gateway number, a component's rated voltage and current value, and a media access control address (MAC address).

In a preferred embodiment, the circuit breaker includes a power supply element coupled to between the input terminal and the control processor, and provided to rectify the external power and generate an operating voltage to the control processor. The circuit breaker includes a warning element coupled to the control processor, such that when the control processor turns off the switch, the control processor drives the warning element to output a warning signal in at least one of the audio and video methods. The circuit breaker includes a temperature sensing element coupled to the control processor, the temperature sensing element is provided for sensing an ambient temperature, the control processor is provided for turning off the switch and generating the OFF signal when comparing the ambient temperature and knowing that the ambient temperature is higher than a safety value, and synchronously transmitting the ambient temperature and the OFF signal to the cloud server; the control processor periodically feeds back the ambient temperature to the cloud server for recording, which is provided for further verifying the corresponding ambient temperature to improve the reliability of the failure signal when the cloud server analyzes the current data or the arc data. The switch is a mechanical switch, and the circuit breaker includes a switch controller coupled between the switch and the control processor; when the control processor receives the computed and known current or arc failure, the control processor outputs an OFF signal to the switch controller to make the switch controller to turn off the switch according to the OFF signal and stop the supply of the external power.

The circuit breaker can further comprises a circuit breaker aging identification processor, which includes a temperature sensing unit. The circuit breaker aging identification processor determines that the wire is in an aging state, causes the switch controller to turn off the switch according to the OFF signal to stop the supply of the external power, and outputs a notification signal when the circuit breaker aging identification processor detects, through the temperature sensing unit, that the temperature rise slope of the wire connected to the circuit breaker is higher than the temperature rise slope of the connector of the circuit breaker and when each temperature of the circuit breaker detected by the temperature sensing unit is greater than an ambient temperature. Also, the circuit breaker aging identification processor can further comprises an oxidation detection unit, which includes a charge plate. The charge plate corresponds to the connector of the circuit breaker, and positive and negative charges of the charge plate and the connector of the circuit breaker are coupled. When the arc detector detects an arc and the charge plate does not generate the coupled negative charges, the oxidation detection unit determines that the connector of the circuit breaker is in an oxidation state, causes the switch controller to turn off the switch according to the OFF signal to stop the supply of the external power, and outputs the notification signal.

The smart circuit breaker management system can further includes a smart home controller connected to the cloud server via the Internet and provided for controlling the circuit breakers. The cloud server at least compiles the corresponding electricity transmission current data, arc data, ambient temperature and failure signal of each of the circuit breakers to analyze and form a corresponding power consumption report accordingly and feeds back the power consumption report to the application platform.

In summation of the description above, the present disclosure constructs the power management system with the smart circuit breakers to achieve the function of collecting the power consumption information of each of the device circuits in real time and further uses the cloud computing technology of the cloud server for real-time computation, determination and analysis of the electricity transmissions, the current data, the arc data, the ambient temperatures and the OFF signals, etc., in order to allow users to operate and control through the mobile device and check the power consumption data or receive failure notification via the Internet anytime and anywhere, without the need of executing the system pre-processing operation of the backstage management host to effectively simplify the system setup. In this way, the present disclosure is suitable for general users to build the smart circuit breaker management system by themselves and achieve the effect of improving the power management deployment in places such as homes or offices. In addition, the present disclosure further uses the first identification codes and the second identification codes provided for the users to perform the installation of the circuit breakers, the panel gateways, and even the smart home controller by scanning, so that the users just need to scan one of the identity codes, and the remaining operation will be processed by the automated process of the application platform, making it convenient for users to build the power management system on their own in places such as home and offices and improving the power protection measures to the greatest extent.

In order to make it easier for the examiner to understand the purpose, technical characteristics and effects of the present disclosure, the specification will now be described in more detail hereinafter with reference to the accompanying drawings that show various embodiments of the present disclosure as follows.

### BRIEF DESCRIPTION OF THE DRAWINGS

FIG. 1 is a schematic diagram of the structure of a first preferred embodiment of the present disclosure;

FIG. 2 is a block diagram of a circuit breaker of the first preferred embodiment of the present disclosure;

FIG. 3 is a flow chart of a system operation of the first preferred embodiment of the present disclosure;

FIG. 4 is a block diagram of a second preferred embodiment of the present disclosure;

FIG. 5 is a block diagram of a circuit breaker of a second preferred embodiment of the present disclosure;

FIG. 6 is a schematic view of an Internet structure of the second preferred embodiment of the present disclosure;

FIGS. 7A and 7B show a flow chart of a system operation of the second preferred embodiment of the present disclosure;

FIG. 8 is a schematic view of an Internet structure of a third preferred embodiment of the present disclosure; and

FIG. 9 is a schematic view of an Internet structure of a fourth preferred embodiment of the present disclosure.

### DETAILED DESCRIPTION OF THE PREFERRED EMBODIMENTS

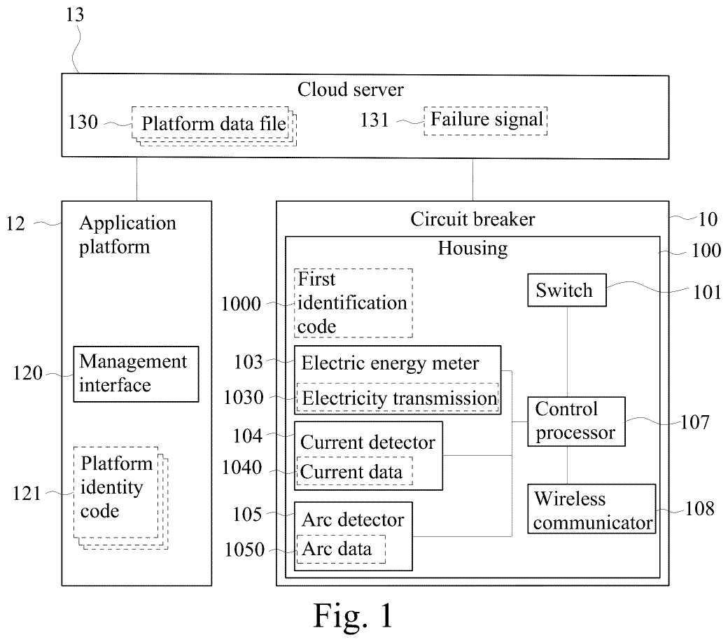

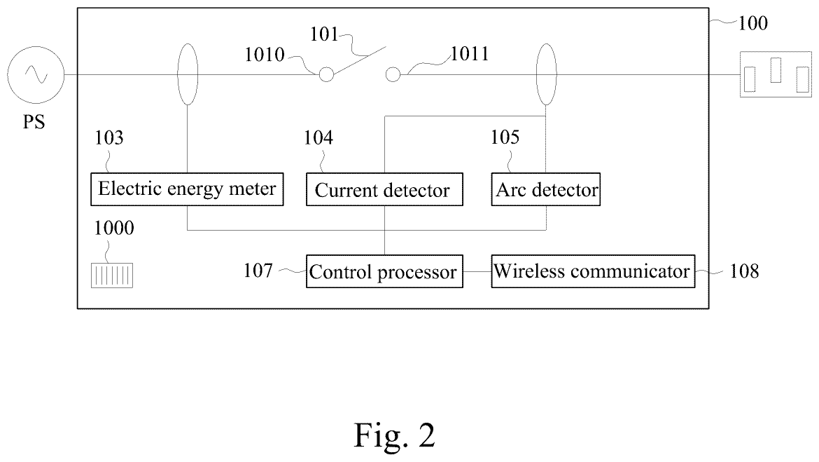

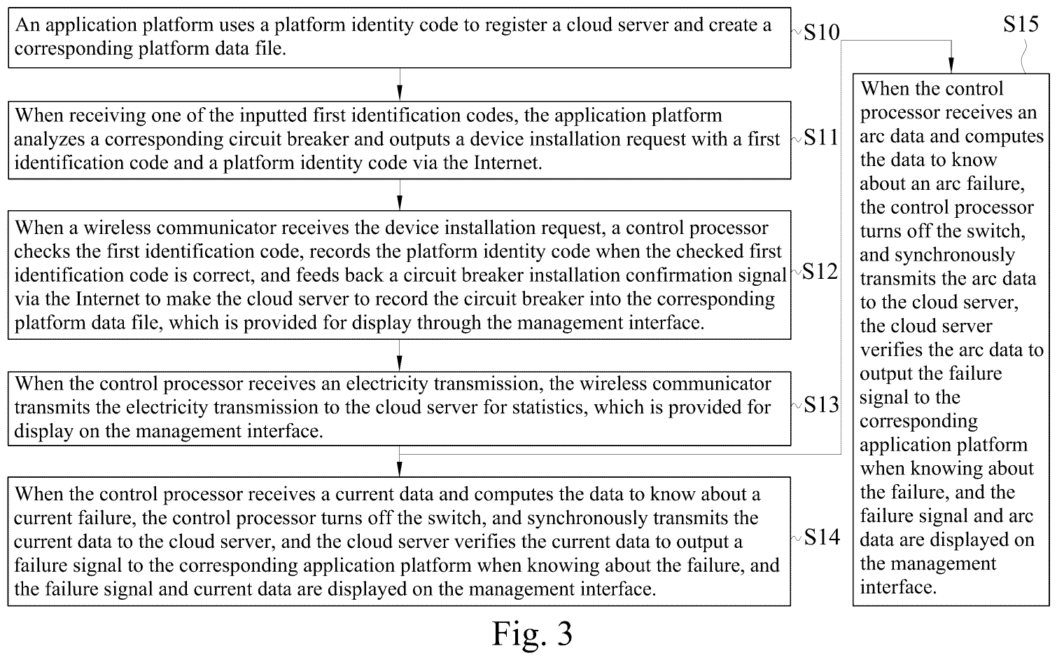

With reference to FIGS. 1 to 3 for a schematic diagram of the structure, a block diagram of a circuit breaker, and a flow chart of a system operation of the first preferred embodiment of the present disclosure respectively, the smart circuit breaker management system 1 is provided for monitoring the power consumption of a plurality of device circuits, and the smart circuit breaker management system 1 includes a cloud server 13, a plurality of application platforms 12 and a plurality of circuit breakers 10, and each of the application platforms 12 is separately installed in at least one mobile device (not shown in the figure), connected to the Internet, and coupled to the cloud server 13, and each the application platform 12 separately has a management interface 120 and a platform identity code 121.

Each of the circuit breaker 10 is a smart circuit breaker installed between an external power supply PS and one of the device circuits, and separately includes a circuit breaker housing 100, a switch 101, an electric energy meter 103, a current detector 104, an arc detector 105, a control processor 107 and a wireless communicator 108. The circuit breaker housing 100 defines an accommodation space of the circuit breaker 10 and includes a first identification code 1000 of a device number, and it is provided for covering the switch 101, the electric energy meter 103, the current detector 104, the arc detector 105, the control processor 107 and the wireless communicator 108. The switch 101 has an input terminal 1010 and an output terminal 1011, the input terminal 1010 is provided for receiving the power of the external power supply PS and the output terminal 1011 is provided for transferring the power to the device circuit. The electric energy meter 103 is coupled to the input terminal 1010 for measuring an electricity transmission 1030 of the external power supply PS, the current detector 104 is coupled to the output terminal 1011 for detecting a current flow and a current direction and then outputting a current data 1040, and the arc detector 105 is also coupled to the output terminal 1011 for detecting a current waveform and a voltage waveform and then outputting an arc data 1050. The control processor 107 is coupled to the switch 101, the electric energy meter 103, the current detector 104, the arc detector 105 and the wireless communicator 108, and provided for receiving the electricity transmission 1030, the current data 1040 and the arc data 1050, and connected to the Internet through the wireless communicator 1080 for transmitting the electricity transmission 1030, the current data 1040 and the arc data 1050 to the cloud server 13.

The operation of the smart circuit breaker management system 1 includes the following steps: In Step S10, the smart circuit breaker management system 1 is installed to one of the application platforms 12 of the mobile device, and the platform identity code 121 is used to register the cloud server 13 and create a corresponding platform data file 130 in the cloud server 13. In Step S11, when receiving one of the inputted first identification codes 1000, the application platform 12 analyzes the corresponding circuit breaker 10 and outputs a device installation request with the first identification code 1000 and the platform identity code 121 via the Internet. In Step S12, when the wireless communicator 108 receives the device installation request, the control processor 107 checks the first identification code 1000 and records the platform identity code 121 when the checked first identification code 1000 is correct, and feeds back a circuit breaker installation confirmation signal via the Internet to make the cloud server 13 to record the circuit breaker 10 into the corresponding platform data file 130, which is provided for display through the management interface 120.

In Step S13, when the control processor 107 receives the electricity transmission 1030, the wireless communicator 108 transmits the electricity transmission 1030 to the cloud server 13 for collecting statistics, which is provided for display on the management interface 120. In Step S14, when the control processor 107 receives the current data and computes the data to know about a current failure, the control processor 107 turns off the switch 101, and synchronously transmits the current data 104 to the cloud server 13, and the cloud server 13 verifies the current data 1040 to output a failure signal 131 to the corresponding application platform 12 when knowing about the failure, and the failure signal 131 and the current data 1040 are displayed on the management interface 120. In Step S15, when the control processor 107 receives the arc data 1050 and computes the data to know about an arc failure, the control processor 107 turns off the switch 101, and synchronously transmits the arc data 1050 to the cloud server 13, the cloud server 13 verifies the arc data 1050 to output the failure signal 131 to the corresponding application platform 12 when knowing about the failure, and the failure signal 131 and the arc data 1050 are displayed on the management interface 120. In this way, after the application platform 12 uses the first identification code 1000 to install the circuit breakers 10 to be monitored, each of the circuit breakers 10 transmits the power related data to the cloud server 13 via the Internet, which is provided for the cloud server 13 to compile and analyze and for display through the management interface 120, so that users can check and control the power consumption at any time.

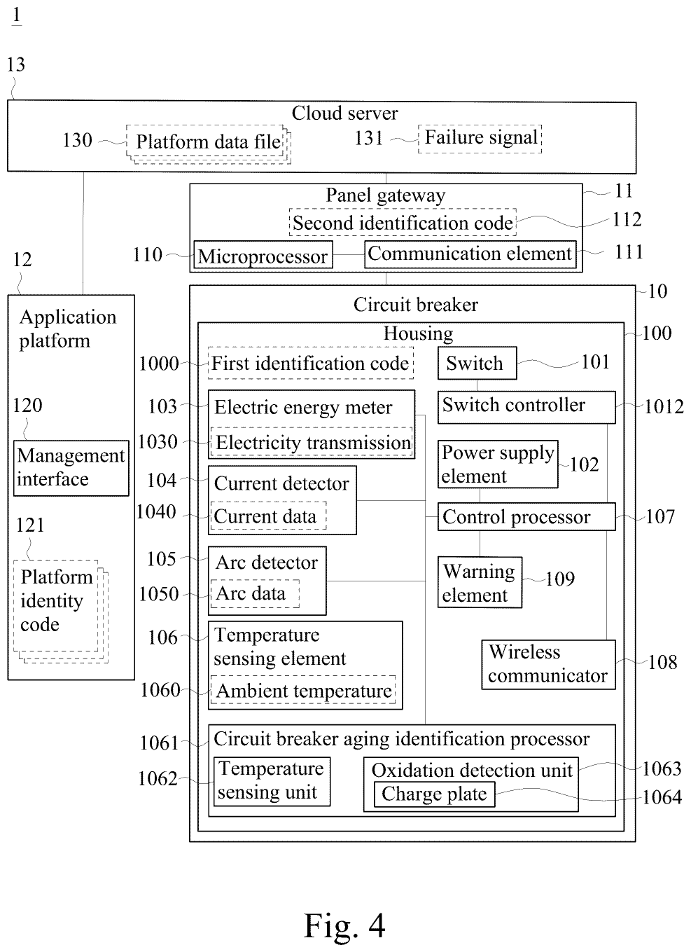

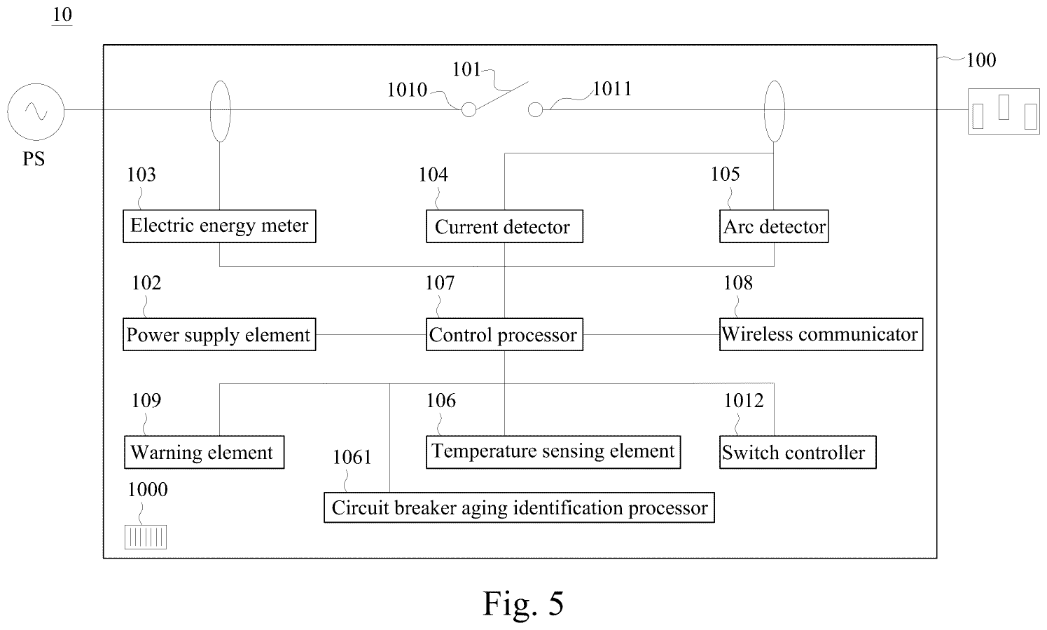

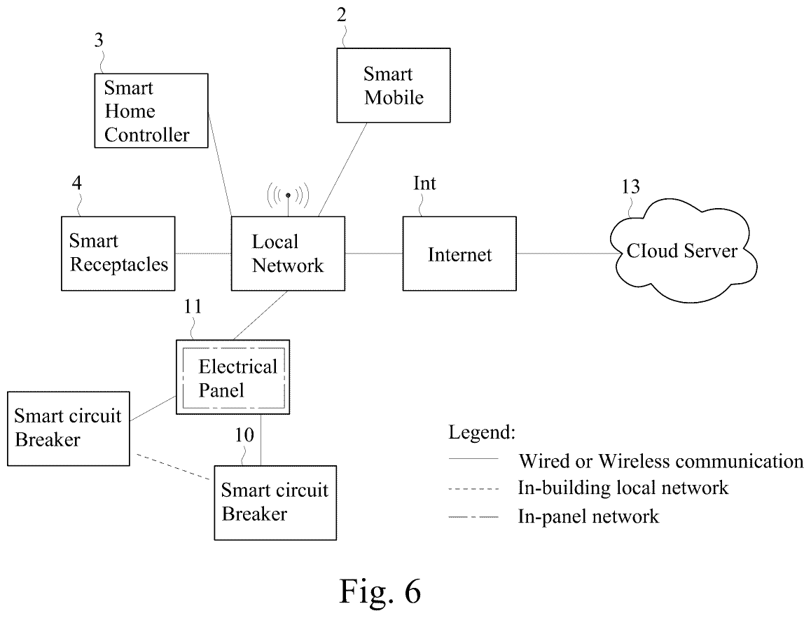

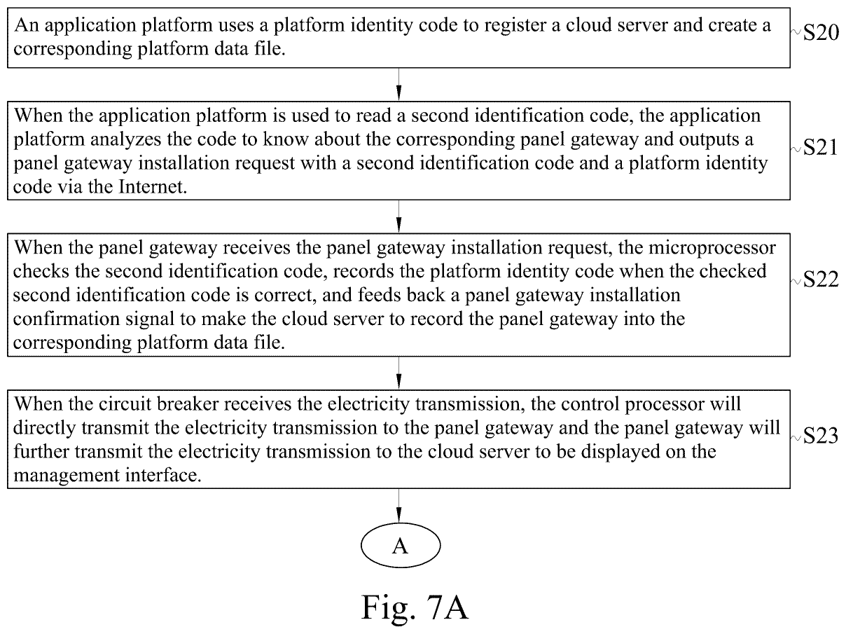

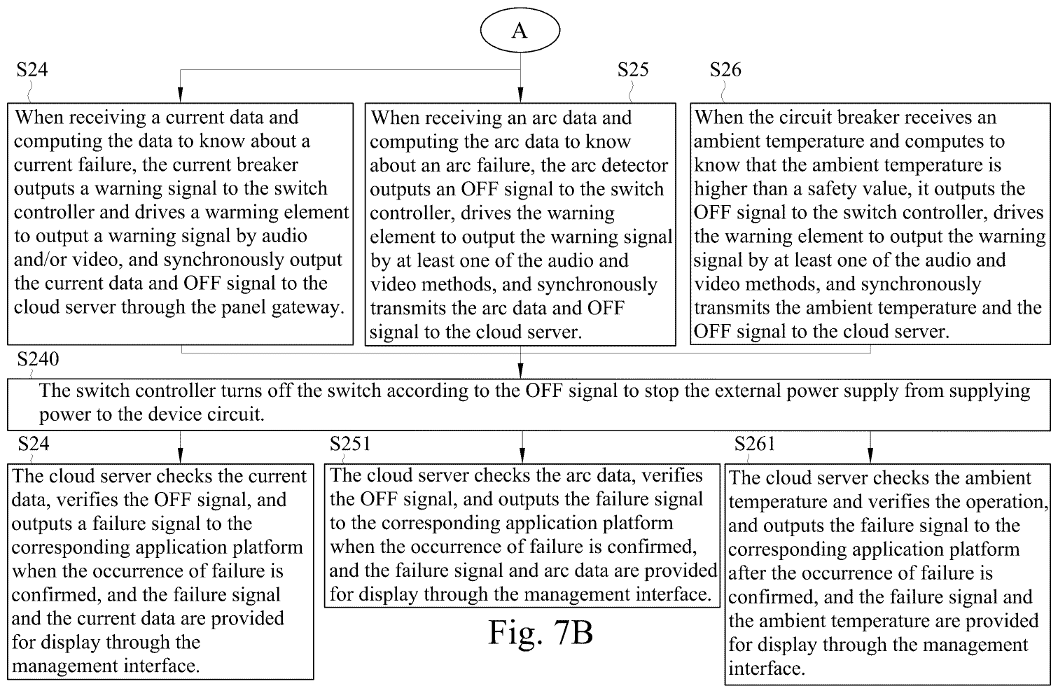

With reference to FIGS. 4 to 7A and 7B the schematic diagram of the structure, the block diagram of a circuit breaker, the schematic diagram of an Internet structure, and the flow charts of a system operation in accordance with the second preferred embodiment of the present disclosure respectively, the smart circuit breaker management system 1 includes a plurality of circuit breakers 10, at least one panel gateway 11, an application platform 12 and a cloud server 13. The smart circuit breaker management system 1 is provided for monitoring the power consumption of a plurality of device circuits (not shown in the figures) via Internet. The circuit breakers 10 are smart circuit breakers, each being installed between an external power supply PS and one of the device circuits, and directly and directly and coupled to or connected to at least one panel gateway 11, and the panel gateway 11 includes a microprocessor 110 and a communication element 111 and is connected to the Internet Int. The application platform 12 can be an application (APP) installed to a mobile device 2 such as a smart phone and a tablet PC and has a management interface 120 and a platform identity code 121, the application platform 12 is coupled to the cloud server 13 via the Internet Int, and the platform identity code 121 is provided for registering the cloud server 13, so as to create a corresponding platform data file 130 in the cloud server 13, which is provided for storing subsequent related data, custom settings, etc. In this way, each of the circuit breaker 10 feeds back the power consumption data to the cloud server 13 by the panel gateway 11 via the Internet Int, which are captured by the application platform 12 for display. In this embodiment, the Internet Int includes a local network (LAN) for home, factory or office, so that the panel gateway 11 and the application platform 12 can connect to the Internet Int through the local network in the local area.

Each of the circuit breakers 10 includes a circuit breaker housing 100, a switch 101, a power supply element 102, an electric energy meter 103, a current detector 104, an arc detector 105, a temperature sensing element 106, a circuit breaker aging identification processor 1061, a control processor 107, a wireless communicator 108, a warning element 109 and a switch controller 1012. The circuit breaker housing 100 covers the switch 101, the power supply element 102, the electric energy meter 103, the current detector 104, the arc detector 105, the temperature sensing element 106, the circuit breaker aging identification processor 1061, the control processor 107, the wireless communicator 108, the warning element 109 and the switch controller 1012. The power supply element 102 is coupled between the input terminal 1010 and the control processor 107, and uses the external power supply PS to rectify and generate an operating voltage to the control processor 107, which is provided for the control processor 107 to be electrically operated. The switch 101 is a mechanical switch installed in the circuit breaker housing 100, and the switch 101 has an input terminal 1010 and an output terminal 1011, where the input terminal 1010 is provided for receiving the power of the external power supply PS, and the output terminal 1011 is provided for transferring the power outputted from the external power supply PS to the device circuit. In addition, the switch controller 1012 is coupled between the switch 101 and the control processor 107 for converting the electric signals of the control processor 107 and switching the ON/OFF state of the switch 101.

The electric energy meter 103 is coupled to the input terminal 1010 for measuring an electricity transmission 1030 of the external power supply PS, the current detector 104 is coupled to the output terminal 1011 for detecting a current flow, a current direction, or a ground fault current and then outputting a current data 1040, the arc detector 105 is coupled to the output terminal 1011 for detecting a current waveform and a voltage waveform and then outputting an arc data 1050, and the temperature sensing element 106 senses an ambient temperature 1060 at the place where the circuit breaker 10 is located. The control processor 107 is coupled to the electric energy meter 103, the current detector 104, the arc detector 105, the temperature sensing element 106, the circuit breaker aging identification processor 1061, the wireless communicator 108 and the warning element 109, and provided for receiving the electricity transmission 1030, the current data 1040, the arc data 1050 and the ambient temperature 1060, and then adaptively controlling the switch 101 through the switch controller 1012, while using the wireless communicator 108 to connect to the Internet Int and transmit the electricity transmission 1030, the current data 1040, the arc data 1050 and the ambient temperature 1060 to the panel gateway 11, and the microprocessor 110 of the panel gateway 11 transmits the above information to the cloud server 13, which is provided for the application platform 12 to review and control.

To allow users to easily build their own smart power management system, each of the circuit breakers 10 separately includes a first identification code 1000 of a device number on the circuit breaker housing 100, and each of the panel gateways 11 separately includes a second identification code 112 of a panel gateway number. The first identification code 1000 and the second identification code 112 can be data matrices, QR Codes or serial number codes, etc. which at least includes the device number or the panel gateway number, a component rated voltage, a current value and a MAC address. The operation of the smart circuit breaker management system 1 includes the following steps.

In Step S20, after a user installs the application platform 12 to the mobile device 2, the platform identity code 121 is provided for registering the cloud server 13 and the corresponding platform data file 130 is created in the cloud server 13. In Step S21, when the application platform 12 scans and reads the second identification code 112 of the panel gateway 11, the application platform 12 analyzes the second identification code 112 to know about the corresponding panel gateway 11 and outputs a panel gateway installation request with the second identification code 112 and the platform identity code 121 via the Internet Int. In Step S22, when the microprocessor 110 of the panel gateway 11 receives the panel gateway installation request through the communication element 111, the microprocessor checks the second identification code 112, and records the platform identity code 121 when the checked second identification code 112 is correct, and feeds back a panel gateway installation confirmation signal via the Internet Int, so that the cloud server 13 records the panel gateway 11 into the corresponding platform data file 130. At this time, the application platform 12 can view the successfully installed panel gateway 11 through the management interface 120. It is noteworthy that when each of the circuit breakers 10 is coupled to the panel gateway 11, the microprocessor 110 reads and records the corresponding device number, and when the microprocessor 110 receives the panel gateway installation request and feeds back the panel gateway installation confirmation signal, the device numbers and the second identification codes 112 are reported altogether and provided for the cloud server 13 to group the panel gateway 11 and the circuit breakers 10 with a connection relation and provided for display through the management interface 120. Therefore, the users just need to scan the second identification code 112 of the panel gateway 11 to build the circuit breakers 10 with the connection relation at a time, so as to facilitate the users to build each of the circuit breakers 10 without the need of scanning the first identification codes 1000 one by one, so as to achieve the effects of effectively reducing the complexity of system construction, facilitating user operation, and improving data service.

Of course, the system can also allow the users to read the first identification code 1000 of each circuit breaker 10 coupled to the panel gateway 11, that is, the users can scan and build the circuit breakers 10 one by one. Therefore, when the application platform 12 receives one of the inputted first identification codes 1000, the application platform 12 analyzes the corresponding circuit breaker 10 and outputs a device installation request with the first identification code 1000 and the platform identity code 121 via the Internet Int, and then when the wireless communicator 108 receives the device installation request, the control processor 107 will check the first identification code 1000 and record the platform identity code 121 when the checked first identification code 1000 is correct, and will feed back a circuit breaker installation confirmation signal via the Internet Int, so that the cloud server 13 records the circuit breaker 10 into the corresponding platform data file 130. At this time, a user may need to set the relation between each circuit breaker 10 and each panel gateway 11, or the cloud server 13 automatically and preliminarily compile and pair according to the information such as the MAC address of each circuit breaker 10 or the platform identity code 121, which are provided for the users to edit on the application platform 12 and confirm the relation between each circuit breaker 10 and each panel gateway 11, and the present disclosure does not limit the operation method.

After the application platform 12 is used to build the panel gateway 11 and each circuit breaker 10 for practical applications, the application platform 12 can receive the current transmission 1030 currently measured by the electric energy meter 103 at any time. In Step S23, when the control processor 107 of the circuit breaker 10 receives the electricity transmission 1030, the control processor 107 will directly transmit the electricity transmission 1030 to the panel gateway 11 through wired connection or through the wireless communicator 108, and the panel gateway 11 will further transmit the electricity transmission 1030 to the cloud server 13 via the Internet Int for recording and collecting statistics purposes, which are displayed on the management interface 120 to allow users to check at any time. In Step S24, when the current detector 104 outputs the current data 1040 to make the control processor 107 to receive the current data 1040, the control processor 107 computes the current data 1040, and outputs an OFF signal to the switch controller 1012 when knowing about a current failure, and drives the warning element 109 to output a warning signal in at least one of the audio or video methods, and the warning signal is provided by the circuit breaker 10 to warn the users about the occurrence of the failure and achieve the effect of quickly locating the failure point, while synchronously transmitting the current data 1040 and the OFF signal to the panel gateway 11, and then the panel gateway 11 transmits them to the cloud server 13. In Step S240, the switch controller 1012 turns off the switch 101 according to the OFF signal to stop the external power supply PS from supplying power to the device circuit. In Step S241, the cloud server 13 checks the current data 1040 and verifies the OFF signal, and outputs a failure signal 131 to the corresponding application platform 12 when the occurrence of failure is confirmed, and the failure signal 131 and the current data 1040 are provided for display through the management interface 120.

In Step S25, when the arc detector 105 outputs the arc data 1050, and the control processor 107 receives the arc data 1050, the control processor 107 computes the arc data 1050, and outputs the OFF signal to the switch controller 1012 when knowing about the arc failure, and drives the warning element 109 to output the warning signal by at least one of the audio and video methods, and synchronously transmits the arc data 1050 and the OFF signal to the panel gateway 11, and then the panel gateway 11 transmits them to the cloud server 13. In Step S240, the switch controller 1012 turns off the switch 101 according to the OFF signal to stop the external power supply PS from supplying power to the device circuit. In Step S251, the cloud server 13 checks the arc data 1050 and verifies the OFF signal, and outputs the failure signal 131 to the corresponding application platform 12 when the occurrence of failure is confirmed, and the failure signal 131 and the arc data 1050 are provided for display through the management interface 120. In Step S26, when the temperature sensing element 106 senses and outputs the ambient temperature 1060 and the control processor 107 receives the ambient temperature 1060, the control processor 107 compares the ambient temperature 1060 knows that the ambient temperature 1060 is higher than a safety value, the control processor 107 outputs the OFF signal to the switch controller 1012 and drives the warning element 109 to output the warning signal by at least one of the audio and video methods, and synchronously transmits the ambient temperature 1060 and the OFF signal to the panel gateway 11, and then the panel gateway 11 transmits them to the cloud server 13. In Step S240, the switch controller 1012 turns off the switch 101 according to the OFF signal to stop the external power supply PS from supplying power to the device circuit. In Step S261, the cloud server 13 checks the ambient temperature 1060 and verifies the OFF signal, and outputs the failure signal 131 to the corresponding application platform 12 after the occurrence of failure is confirmed, and the failure signal 131 and the ambient temperature 1060 are provided for display through the management interface 120.

Continued with the above, when the cloud server 13 checks the current data 1040, the arc data 1050 or the ambient temperature 1060 and finds that the OFF signal is wrong, the cloud server 13 generates and sends an abnormal signal to each of the application platforms 12, and notifies users through the management interface 120 to examine the corresponding circuit breaker 10, so as to remind users to check whether the circuit or components of the circuit breaker 10 is abnormal and requires maintenance or replacement, and improve the working quality and reliability of each of the circuit breakers 10. In summation of the description above, after the panel gateway 11 uses the microprocessor 110 to compile the data transmitted from the control processor 107 of each of the circuit breakers 10, the communication element 111 is used to transfer the data to the cloud server 13, so as to achieve the effects of increasing the data transmission distance, perfecting the communication quality, and assuring the data accuracy.

In this embodiment, the control processor 107 can periodically feed the ambient temperature 1060 back to the cloud server 13 through the panel gateway 11 for recording and allowing the cloud server 13 to analyze and obtain the average ambient temperature and the temperature change frequency and trend of the circuit breakers 10, in addition to feeding back the OFF signal and the ambient temperature 1060 when the ambient temperature 1060 is higher than the safety value. When the cloud server 13 analyzes the current data 1040 or the arc data 1050, the corresponding ambient temperature 1060 is further used for verification, so as to improve the reliability of the issuance of the failure signal 131. In other words, the cloud server 13 further compiles at least the corresponding electricity transmission 1030, the current data 1040, the arc data 1050, the ambient temperature 1060 and the OFF signal of each of the circuit breakers 10, and compiles the known working change of each of the circuit breakers 10 and analyzes and forms a corresponding power consumption report, which are fed back to the application platform 12 to assist users to further control the power consumption status, and achieve the effects of perfecting the power deployment and the power usage strategy.

The smart circuit breaker management system 1 further includes a smart home controller 3 connected to a local network and connected to the cloud server 13 via the Internet Int for obtaining the failure signal 131, so as to provide users diversified ways of controlling the circuit breakers 10. Further, the smart circuit breaker management system 1 can be equipped with a plurality of smart receptacles 4 provided for the users to group and set the panel gateway 11 and each of the circuit breakers 10 in the application platform 12, similarly, connecting the Internet Int through the local network and connecting the cloud server 13, so that when one of the circuit breakers 10 cuts off the power of the external power supply PS and the cloud server 13 transmits the failure signal 131, the corresponding smart receptacle 4a receives the failure signal 131 and displays warning to assist users to quickly locate the failed device and turn off or repair the electric appliances or equipment, so as to achieve the effect of perfecting the electricity safety and data experience.

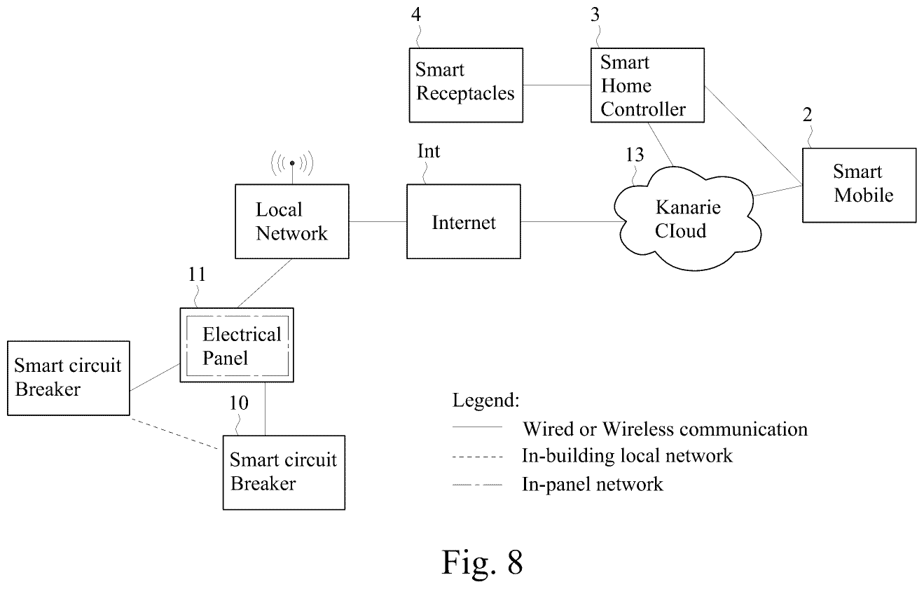

The present disclosure uses the cloud computing technology of the cloud server 13 for real-time computation, determination and analysis of the electricity transmissions 1030, the current data 1040, the arc data 1050, the ambient temperatures 1060 and the OFF signals, so as to achieve the effect of instantly providing feedbacks to the failure signal 131 and each data to users. The smart circuit breaker management system 1 is not limited to the Internet structure of the second preferred embodiment only, but it can also be the Internet structure as shown in FIG. 8. The panel gateway 11 connected with the circuit breakers 10 after being connected to the local network can be connected to the cloud server 13 via the Internet Int, and the mobile device 2 and the smart home controller 3 are connected to the cloud server 13, so that when the circuit breakers 10 feeds back the sensed data, and the panel gateway 11 compiles and sends data back to the cloud server 13, the application platform 12 and the smart home controller 3 can obtain the failure signal 131 and related data from the cloud server 13. In addition, the smart receptacles 4 are connected to the smart home controller 3 for obtaining the failure signal 131 from the smart home controller 3, and the smart receptacle 4 can further issue a light warning or an alarm buzzer according to the failure signal 131, or the smart home controller 3 is passively controlled by the smart home controller 3. The mobile device 2 is connected to the smart home controller 3 and provided for the users to control and operate the smart home controller 3 through the application platform 12 or indirectly control and operate the smart receptacles 4 through the smart home controller 3. The cloud server 13 is a Kanarie Cloud provided for the cloud computation resources, and makes the present disclosure further to have the flexible extended computation resources and service scale, so that under the premise of meeting actual business needs, the manufacturing and service costs of the smart circuit breaker management system 1 can be more effectively controlled, which is beneficial to the development and progress of the industry.

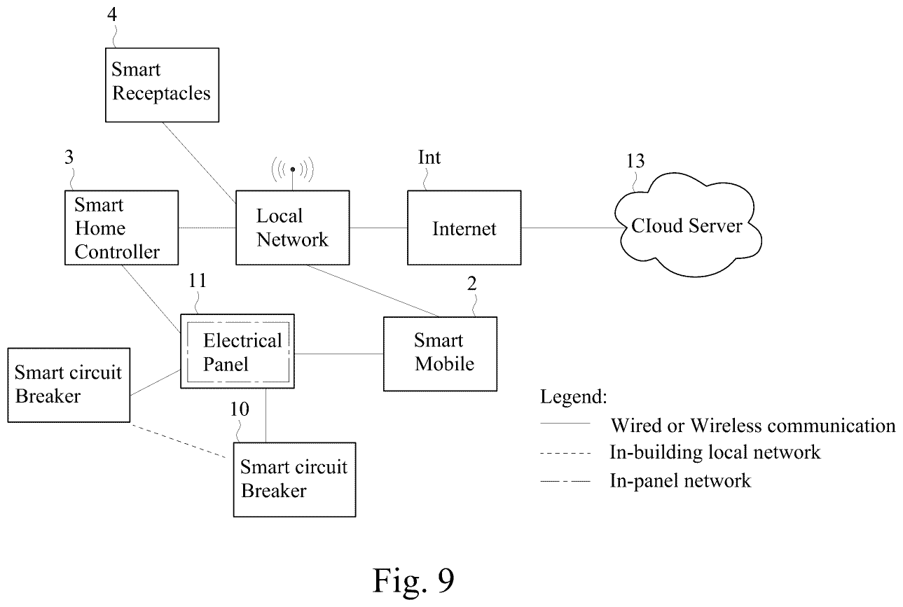

In addition, the smart circuit breaker management system 1 can also be implemented in the Internet structure as shown in FIG. 9, the mobile device 2 installed with the application platform 12 is connected to the panel gateway 11 and the local network, the smart home controller 3 is also directly and connected to the panel gateway 11 and the local network, and the panel gateway 11 is connected to the circuit breakers 10. When the control processor 107 of the circuit breaker 10 receives the current data 1040, the arc data 1050 or the ambient temperature 1060 and computes to know about a current or arc failure, or an excessive high temperature that may harm the operation of the devices, the switch will be turned off and the OFF signal will be generated. At this time, the circuit breaker 10 sends the OFF signal and related data to the cloud server 13 by the communication function of the mobile device 2 or the smart home controller 3 via the local network which is connected to the Internet Int. Therefore, the application platform 12 and the smart home controller 3 can synchronously obtain the OFF signal of the switch 101 in the first moment, and let the user know about the power abnormality of any one of the device circuits immediately, and the device circuit has already cut off the power supply of the corresponding circuit breaker 10 and stop the operation, so as to urge the user to make responses and handling the situation in the shortest possible time. At the same time, it is expected that the time that each electrical equipment in the place is suspended due to the fact that the failure will be shortened, thereby achieving the effect of improving the comfort of space experience for everyone in the place. Of course, in this embodiment, the cloud server 13 still checks the data, verifies the OFF signal, and outputs the failure signal 131 to the corresponding application platform 12 when the occurrence of the failure is confirmed, so that the user can verify the OFF signal. If the OFF signal is incorrect, the user can also quickly check whether the corresponding circuit breaker 10 or the panel gateway 11 is abnormal, so as to completely eliminate the problem and realize the highest level of electricity safety protection.

It is worth knowing that since the connector of the circuit breaker 10 is connected to external wires, the present application can also have another embodiment. In this embodiment, a circuit breaker aging identification processor 1061 includes a temperature sensing unit 1062. Normally, a temperature rise slope of the wire connected to the circuit breaker 10 is higher than a temperature rise slope of a connector of the circuit breaker 10. Therefore, when the circuit breaker aging identification processor 1061 detects, through the temperature sensing unit 1062, that a temperature rise slope of the wire connected to the circuit breaker 10 is higher than a temperature rise slope of a connector of the circuit breaker 10 and when each temperature of the circuit breaker 10 detected by the temperature sensing unit 1062 is greater than an ambient temperature 1060, the wires connected to the circuit breaker 10 are in an aging state and are prone to produce high resistance, which would cause an electrical fault. So, the circuit breaker aging identification processor 1061 would cause the switch controller 1012 to turn off the switch 101 according to the OFF signal to stop the supply of the external power and output a notification signal to notify that the wires are in an aging state and need to be replaced. Furthermore, the circuit breaker aging identification processor 1061 can also comprises an oxidation detection unit 1063, which includes a charge plate 1064. The charge plate 1064 corresponds to the connector of the circuit breaker 10, and positive and negative charges of the charge plate 1064 and the connector of the circuit breaker 10 are coupled. Under normal conditions, when there is no current transmission in the circuit breaker 10, the connector of the circuit breaker 10, which is electrically coupled to the charge plate 1064, is not charged and maintains a charge balance state with the charge plate 1064. When the connector starts to transmit current and the power-transmitting metal in the connector transmits power through the flow of negatively charged electrons, the surface of the power-transmitting metal accumulates positive charges. Therefore, when the charge plate 1064 is close to the power-transmitting metal and couples to the positive charge on the surface of the power-transmitting metal, the charge plate 1064 generates coupled negative charges. However, when the arc detector detects an arc and the charge plate 1064 does not generate the coupled negative charges (that is, when there is no positive charge on the surface of power-transmitting metal of the connector of the circuit breaker 10), it is determined that the connector of the circuit breaker 10 is in an oxidized state due to the production of oxide film. In this state, the connector of the circuit breaker 10 is difficult to transmit power or may cause the temperature to rise to break down the circuit breaker 10. Therefore, the circuit breaker aging identification processor 1061 would cause the switch controller 1012 to turn off the switch 101 according to the OFF signal to stop the supply of the external power and output the notification signal to notify that the circuit breaker 10 needs to be replaced or repaired to take away the oxide film.

What is claimed is:

1. A smart circuit breaker management system, provided for monitoring power consumption of a plurality of device circuits via an Internet, comprising:
a cloud server;
a plurality of application platforms, separately installed in at least one mobile device, coupled to the Internet, and coupled to the cloud server, each of the plurality of application platforms having a management interface and a platform identity code, and the platform identity code being provided for registering in the cloud server to create a corresponding platform data file; and
a plurality of circuit breakers, being smart circuit breakers, and installed between an external power supply and one of the plurality of device circuits, and each circuit breaker comprising:
a circuit breaker housing, defining an accommodation space of the circuit breaker, and including a first identification code of a device number, wherein when a corresponding application platform receives one of inputted first identification codes, the corresponding application platform analyzes the circuit breaker and outputs a device installation request including the first identification code and the platform identity code via the Internet;
a switch, installed in the circuit breaker housing and having an input terminal and an output terminal, wherein the input terminal connects to the external power supply such that the output terminal transfers an external power to a corresponding device circuit;
an electric energy meter, installed in the circuit breaker housing and electrically coupled to the input terminal, for measuring an electricity transmission of the external power;
a current detector, installed in the circuit breaker housing and electrically coupled to the output terminal, for detecting a current flow, a current direction, or a ground fault current and outputting a current data;
an arc detector, installed in the circuit breaker housing and electrically coupled to the output terminal, for detecting a current waveform and a voltage waveform and outputting an arc data;
a control processor, installed in the circuit breaker housing and electrically coupled to the switch, the electric energy meter, the current detector, and the arc detector, for receiving the electricity transmission, the current data, and the arc data; and
a wireless communicator, installed in the circuit breaker housing, electrically coupled to the control processor, and coupled to the Internet, wherein when the wireless communicator receives the device installation request, the control processor checks the first identification code, records the platform identity code when the checked first identification code is correct, and feeds back a circuit breaker installation confirmation signal via the Internet, so that the cloud server records the circuit breaker into the corresponding platform data file provided for display through the management interface,
the control processor receives the electricity transmission, the wireless communicator transmits the electricity transmission to the cloud server for collecting statistics which is provided for display through the management interface,
when the control processor detects a current failure by receiving and calculating the current data, the control processor turns off the switch, generates an OFF signal accordingly, and synchronously transmits the current data and the OFF signal to the cloud server, the cloud server checks the current data, verifies the OFF signal, and outputs a failure signal to the corresponding application platform upon a confirmation of the current failure, and the failure signal and the current data are provided for display through the management interface, and
when the control processor detects an arc failure by receiving and calculating the arc data, the control processor turns off the switch, generates the OFF signal accordingly, and synchronously transmits the arc data and the OFF signal to the cloud server, the cloud server checks the arc data, verifies the OFF signal, and outputs the failure signal to the corresponding application platform upon a confirmation of the arc failure, and the failure signal and the arc data are provided for display through the management interface.

2. The smart circuit breaker management system according to claim 1, further comprising at least one panel gateway including a microprocessor and a communication element coupled to the Internet, the at least one panel gateway being electrically coupled to each of the plurality of circuit breakers,
wherein the microprocessor is provided for compiling data transmitted from the control processor in each of the plurality of circuit breakers, and the communication element is provided for transferring the data to the cloud server to achieve an effect of increasing data transmission distance.

3. The smart circuit breaker management system according to claim 2, wherein each of the at least one panel gateway has a second identification code of a panel gateway number, and when the corresponding application platform receives one of inputted second identification codes, the corresponding application platform analyzes the at least one panel gateway and outputs a panel gateway installation request including the second identification code and the platform identity code via the Internet, and
the microprocessor receives the panel gateway installation request through the communication element and checks the second identification code, records the platform identity code when the checked second identification code is correct, and feeds back a panel gateway installation confirmation signal via the Internet, so that the cloud server records the at least one panel gateway into the corresponding platform data file.

4. The smart circuit breaker management system according to claim 3, wherein when each of the plurality of circuit breakers is electrically coupled to the at least one panel gateway, the microprocessor reads and records a corresponding device number to receive the panel gateway installation request and feeds back the panel gateway installation confirmation signal and reports the device numbers, the second identification code and the device numbers are provided for the cloud server to group the at least one panel gateway and the plurality of circuit breakers in connection with the cloud server, and are provided for display through the management interface.

5. The smart circuit breaker management system according to claim 4, wherein each of the first identification code and the second identification code is a data matrix, a quick response (QR) code, or a serial number code, each of the first identification code and the second identification code comprises, at least, the device number or the panel gateway number, a component rated voltage value, a component rated current value, and a media access control (MAC) address.

6. The smart circuit breaker management system according to claim 1, wherein the circuit breaker further comprises a power supply element electrically coupled between the input terminal and the control processor, and the external power supply is provided for rectifying to form an operating voltage to the control processor.

7. The smart circuit breaker management system according to claim 1, wherein the circuit breaker further comprises a warning element electrically coupled to the control processor, and when the control processor turns off the switch, the control processor drives the warning element to output a warning signal by sound and/or visual.

8. The smart circuit breaker management system according to claim 1, wherein the circuit breaker further comprises a temperature sensing element electrically coupled to the control processor for sensing an ambient temperature, the control processor compares the ambient temperature with a safety value, and when the ambient temperature is higher than the safety value, the control processor turns off the switch, generates the OFF signal, and synchronously transmits the ambient temperature and the OFF signal to the cloud server, and
the control processor periodically feeds back the ambient temperature to the cloud server for recording, and when the cloud server analyzes the current data or the arc data, a corresponding ambient temperature is further used for a verification to improve a reliability of the failure signal.

9. The smart circuit breaker management system according to claim 1, wherein the switch is a mechanical switch, and the circuit breaker further comprises a switch controller electrically coupled between the switch and the control processor, and
when the control processor detects the current failure or the arc failure, the control processor outputs the OFF signal to the switch controller, and the switch controller turns off the switch to stop supply of the external power according to the OFF signal.

10. The smart circuit breaker management system according to claim 9, wherein the circuit breaker further comprises a circuit breaker aging identification processor, which includes a temperature sensing unit, and
the circuit breaker aging identification processor determines that a wire is in an aging state, causes the switch controller to turn off the switch according to the OFF signal to stop the supply of the external power, and outputs a notification signal when:
the circuit breaker aging identification processor detects, through the temperature sensing unit, that a temperature rise slope of the wire connected to the circuit breaker is higher than a temperature rise slope of a connector of the circuit breaker, and
each temperature of the circuit breaker detected by the temperature sensing unit is greater than an ambient temperature.

11. The smart circuit breaker management system according to claim 10, wherein the circuit breaker aging identification processor further comprises an oxidation detection unit, which includes a charge plate,
the charge plate corresponds to the connector of the circuit breaker, and positive and negative charges of the charge plate and the connector of the circuit breaker are coupled, and
when the arc detector detects an arc and the charge plate does not generate the coupled negative charges, the oxidation detection unit determines that the connector of the circuit breaker is in an oxidation state, causes the switch controller to turn off the switch according to the OFF signal to stop the supply of the external power, and outputs the notification signal.

12. The smart circuit breaker management system according to claim 1, further comprising a smart home controller coupled to the cloud server via the Internet for controlling the plurality of circuit breakers.

13. The smart circuit breaker management system according to claim 1, wherein the cloud server integrates the electricity transmission, the current data, the arc data, the ambient temperature, and the OFF signal corresponding to each of the plurality of circuit breakers to analyze and form a corresponding power consumption report, and the cloud server feeds back the power consumption report to the corresponding application platform.
